(19) United States
(12) Patent Application Publication
(10) Pub. No.: US 2026/0152096 A1
(43) Pub. Date: Jun. 4, 2026

(54) VEHICLE WITH FUEL CELL AND METHOD FOR THE OPERATION THEREOF

(71) Applicant: DAIMLER TRUCK AG, Leinfelden-Echterdingen (DE)

(72) Inventors: Jonathan Hans-Peter BAIER, Stuttgart (DE); Reinhard BLANKE, Stuttgart (DE); Richard KINDICH, Stuttgart (DE); Eugen KREBS, Stuttgart (DE)

(21) Appl. No.: 19/122,330

(22) PCT Filed: Oct. 13, 2023
(86) PCT No.: PCT/EP2023/078579

§ 371 Date: Apr. 18, 2025

(30) Foreign Application Priority Data
Oct. 21, 2022 (DE) 10 2022 127 908.1

(51) Int. Cl. B60L 58/33; B60K 11/04; B60L 50/71

(52) U.S. Cl. CPC B60L 58/33; B60K 11/04; B60L 50/71; B60L 2200/36

(57) ABSTRACT

A fuel cell vehicle includes a cooling system with at least one radiator for cooling the fuel cell, a container for collecting water generated in the fuel cell, a plurality of nozzles arranged in front of the radiator in the direction of travel for directing or spraying water from the container onto the radiator or into an air flow flowing through the radiator, a pump for conveying the water from the container to the nozzles, and a controller configured to control and/or to regulate the pump with regard to the quantity of water conveyed, depending on the outside temperature and a temperature of the cooling system. The vehicle is a commercial vehicle. The radiator is arranged on a roof or in the region of the roof of the vehicle and the container is arranged in a lower region of the vehicle.

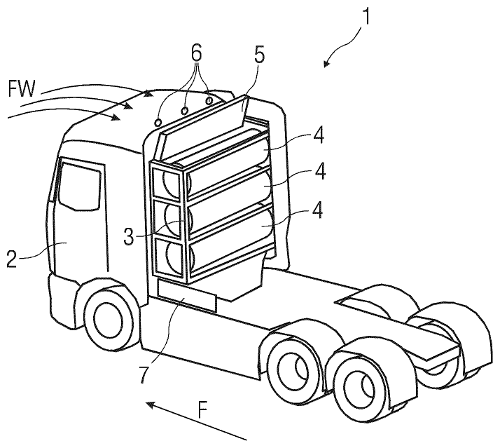

### BACKGROUND AND SUMMARY OF THE INVENTION

Exemplary embodiments of the invention relate to a vehicle with a fuel cell, as well as to a method for the operation.

JP 2019-075254 A2 describes a fuel cell system comprising a fuel cell, in which hydrogen and oxygen are electrochemically reacted and water is generated by the electrochemical reaction, water storage parts for storing water collected in the fuel cell, a heat exchanger that emits heat from the exchange of a heat exchange medium that receives heat from the fuel cell, a spraying part for spraying water from the water storage parts onto the heat exchanger to cool the heat exchanger using latent heat of vaporization, and an anomaly determining part for determining an anomaly with respect to the water spraying of the spraying part. The anomaly determining part carries out an anomaly determination based on the difference of the theoretical heat release of the heat exchanger when no water is sprayed onto the heat exchanger and an actual measured heat release of the heat exchanger when water is sprayed on the heat exchanger.

Exemplary embodiments of the invention are directed to a novel vehicle with a fuel cell and a novel method for the operation thereof.

A vehicle according to the invention comprises at least one fuel cell, a cooling system with at least one radiator for cooling the fuel cell, a container for collecting water generated in the fuel cell, a plurality of nozzles arranged in front of the radiator in the direction of travel for directing or spraying water from the container onto the radiator or into an air flow flowing through the radiator, a pump for conveying the water from the container to the nozzles, and a controller configured to control and/or to regulate the pump with regard to the quantity of water conveyed, depending on the outside temperature and a temperature of the cooling system. According to the invention, the vehicle is designed as a commercial vehicle, wherein the radiator is arranged on a roof or in the region of the roof of the vehicle, wherein the container is arranged in a lower region of the vehicle.

Spraying water onto a warm and/or hot radiator improves the cooling performance. A cooling capacity is created by the evaporation of the water. Thus, an energy saving, an improvement in the degree of efficiency of the radiator and thus a better degree of efficiency of the overall system, including the fuel cell, is achieved. This results in a reduction of the ecological footprint, since more range is achieved with the same use of primary energy.

Exemplary embodiments of the invention are explained in more detail below by means of a drawing.

### BRIEF DESCRIPTION OF THE SOLE DRAWING FIGURE Here are shown in:

The sole drawing FIGURE is a schematic view of a commercial vehicle with fuel cell drive.

### DETAILED DESCRIPTION

The sole drawing FIGURE is a schematic view of a commercial vehicle 1, in particular a tractor unit for an articulated lorry. The commercial vehicle 1 has a drive based on one or more fuel cells. For this purpose, a technology tower 3 is arranged behind a cab 2 of the commercial vehicle 1, in which technology tower in particular one or more hydrogen tanks 4 are arranged. A radiator 5 is arranged on a roof of the cab 2 or on the technology tower 3 in the roof region.

A fuel cell vehicle generates a lot of waste heat. This is further increased by the need for cooling power when decelerating the vehicle. When recuperation is not possible, electrical energy must then be converted into heat, which must be dissipated via the radiator 5.

One or more nozzles 6 are arranged in front of the radiator 5 in the direction of travel F, from which nozzles water can be sprayed onto the radiator 5. The water is generated as a spray mist by the fuel cell, discharged from it and collected in a container 7. In a commercial vehicle 1, for example, around 50 liters of water can accumulate per hour. The water is introduced via the nozzles 6 as a flow of water or as a spray mist into an air flow which flows through the radiator 5, or is sprayed directly onto the radiator 5.

The radiator 5 is blown by the air flow, for example the headwind FW while driving. The nozzles 6 are arranged in this air flow and can be formed similarly to the nozzles for the cleaning water of a windscreen. The nozzles 6 are supplied with the water from the container 7. In particular, the entire radiator 5 is thus wetted, and the radiator 5 is additionally cooled as a result of evaporation enthalpy, for example by around two degrees to three degrees more than without spraying.

The container 7 for collecting the water from the fuel cell is located, for example, in a lower area of the commercial vehicle 1. The water is conveyed from the container 7 to the nozzles 6 by means of a pump (not depicted). Alternatively, the spray mist generated by the fuel cell can also be applied directly onto the radiator 5.

Furthermore, a controller (not depicted) can be provided that decides when and how much water is sprayed depending on at least one temperature, for example the outside temperature and/or a temperature of the cooling system of the commercial vehicle 1.

Furthermore, a collecting device (not depicted), for example a trough or channel, can be provided behind the radiator 5 in the direction of travel F to collect some of the sprayed water that may not have evaporated. A drain from this collecting device, for example towards the container 7, can be guided along an ascending and thus warmer conduit to the radiator 5 and wet it. In this way, this conduit is also additionally cooled due to the enthalpy of vaporization and the cooling effect is increased.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE NUMBERS

1 Commercial vehicle
2 Cab
3 Technology tower
4 Hydrogen tank
5 Radiator
6 Nozzle
7 Container
F Direction of travel
FW Headwind

1-6. (canceled)

7. A vehicle comprising:
at least one fuel cell;
a cooling system comprising
at least one radiator configured to cool the at least one fuel cell;
a container configured to collect water generated in the at least one fuel cell;
a plurality of nozzles arranged in front of the radiator in a direction of travel of the vehicle, wherein the plurality of nozzles are configured to direct or spray water from the container onto the radiator or into an air flow flowing through the radiator;
a pump configured to convey the water from the container to the nozzles; and
a controller configured to control or regulate, depending on an outside temperature and a temperature of the cooling system, a quantity of water conveyed by the pump,
wherein the vehicle is a commercial vehicle,
wherein the radiator is arranged on a roof or in a region of the roof of the vehicle, and
wherein the container is arranged in a lower region of the vehicle.

8. The vehicle of claim 7, wherein the air flow is generated by a headwind.

9. The vehicle of claim 7, wherein the plurality of the nozzles are arranged to wet an entirety of the radiator.

10. The vehicle of claim 7, further comprising:
a collecting device arranged behind the radiator in the direction of travel of the vehicle and configured collect some of the water sprayed onto the radiator that may not have evaporated, wherein the collecting device has a drain guided along an ascending conduit to the radiator and is configured to wet the radiator with the water collected by the collecting device.

11. The vehicle of claim 7, further comprising:
a cab; and
a technology tower arranged behind the cab, wherein hydrogen tanks are arranged in the technology tower, wherein the radiator is arranged in a region of the roof of the cab on the technology tower.

12. A method for operating a vehicle with at least one fuel cell and a cooling system with at least one radiator for cooling the fuel cell, the method comprising:
collecting water generated in the fuel cell in a container;
conveying, by a pump to a plurality of nozzles arranged in front of the radiator in a direction of travel of the vehicle, the water from the container; and
directing or spraying, by the plurality of nozzles, the water onto the at least one radiator or into an air flow flowing through the at least one radiator, wherein a quantity of the water conveyed by the pump is controlled or regulated by a controller depending on an outside temperature and a temperature of the cooling system,
wherein the vehicle is a commercial vehicle,
wherein the at least one radiator is arranged on a roof or in a region of the roof of the vehicle, and
wherein the container is arranged in a lower region of the vehicle.
